(19) United States
(12) Patent Application Publication
(10) Pub. No.: US 2017/0066626 A1
(43) Pub. Date: Mar. 9, 2017

(54) RAIL SECURING DEVICES FOR AN ELEVATOR INSTALLATION

(71) Applicant: INVENTIO AG, Hergiswil (CH)

(72) Inventor: Alberto YOSHIYUKI HOSODA, Sao Paulo (BR)

(21) Appl. No.: 15/308,124

(22) PCT Filed: Apr. 23, 2015
(86) PCT No.: PCT/EP2015/058858

§ 371 Date: Nov. 1, 2016

(30) Foreign Application Priority Data
May 1, 2014 (EP) 14166777.4

(51) Int. Cl. B66B 5/00; B66B 7/02; B66B 7/12; B66B 19/00

(52) U.S. Cl. CPC B66B 5/0087; B66B 19/002; B66B 7/023; B66B 7/1246

(57) ABSTRACT

An impact device for an elevator installation includes an impact part and a free-fall mass. The impact part is arranged on a rail of the elevator installation such that the impact part is supported on a sliding bracket attached to the rail. The free-fall mass is guided so as to move relative to the impact part. The guiding of the free-fall mass is configured such that the free-fall mass, initially raised to a determined free-fall height, transmits to the sliding bracket, at the end of its free-fall path and via the impact part supported on the sliding bracket, an impulse which is dependent on the determined free-fall height. Further, the impact device can be used in a method for post-adjusting rail securing devices for an elevator installation.

### FIELD

The invention pertains to a method for realigning rail securing devices of an elevator installation, as well as to an impact device for elevator installations. In this case, the elevator installation may serve, among other things, for transporting persons and goods.

### BACKGROUND

WO 2014/001373 A1 discloses a holding device and a method for securing and aligning a guide rail. The known holding device features at least one fixing mechanism, which comprises elements for aligning and fixing the guide rail in the elevator installation. This holding device makes it possible to eliminate the alignment of the guide rail, for example, by means of an impact tool during the installation such that the installation time is reduced.

The holding device and the method known from WO 2014/001373 A1 have the disadvantage that subsequently occurring relative length changes cannot be compensated because the guide rails of the elevator installation are fixed at certain points by means of the holding devices. When elevator installations are installed in new buildings, it is particularly problematic that permanent length changes of the buildings can still take place over an extended period of time, for example up to one year. Progressive curing of concrete building parts, for example, can lead to contractions whereas such contractions do not occur on the guide rails. The resulting mechanical stresses lead to bending of the holding devices and/or a corresponding support structure depending on the design of the holding devices.

It would be conceivable to utilize sliding clamps, which allow a certain longitudinal displacement of the guide rails held by the sliding clamps, for securing the guide rails in the elevator shaft when an elevator installation is installed. In this way, a relative motion along the length of the installed guide rail can be realized at the respective location, at which a sliding clamp holds the guide rail.

However, securing guide rails by means of such sliding clamps is also associated with functional limitations. For example, sudden jamming or warping of the sliding clamps on the guide rails can occur. This may be the result, for example, of tolerance-related thickness fluctuations in the rail flanges and subsequently prevent any further sliding motion. Consequently, a realignment of the guide rails is frequently also required when sliding clamps are used. This means that the individual rail securing devices have to be removed in order to subsequently align the rails, whereupon the rails have to be reinstalled in a correspondingly elaborate process. On the other hand, it would also be conceivable to realize the realignment by utilizing an impact tool such as a hammer or a lever mechanism for forcing the guide rails back into their position. However, the use of such tools or mechanisms can lead to mechanical damages or even to overtensioning of the securing devices if excessively high forces are applied.

### SUMMARY

The invention is based on the objective of disclosing a method for realigning rail securing devices of an elevator installation, as well as an impact device for elevator installations, by means of which an improved realignment of guide rails can be achieved. The invention particularly aims to disclose a method and an impact device of the above-described type, by means of which rails, particularly guide rails of an elevator installation, can be reliably and reproducibly realigned with a minimal expenditure of time.

Solutions and proposals for a corresponding method and a corresponding device, which attain at least parts of the above-defined objective, are presented below. Furthermore, advantageous completive or alternative enhancements and embodiments are described.

An impact device capable of generating a predefined or pre-adjustable impact energy is advantageously used for realigning rails of an elevator installation. The sliding securing device is released from its tensioned position by means of the impact energy such that the system is once again approximately reset into its nominal position. The impact device provides a tool and a corresponding method, by means of which guide rails can be easily realigned without removing the securing devices. In contrast to the use of a hammer or the like, overtensioning of the system or damages to the securing devices are thereby prevented during the realignment. In this case, the impact generated when the free-fall mass strikes the impact part can be reproducibly and purposefully applied. This solution simplifies the realignment. Furthermore, the expenditure of time required for the realignment can be reduced.

The impact device for elevator installations comprises an impact part and a free-fall mass, wherein the impact part can be arranged on a rail of the elevator installation in such a way that the impact part is supported on a sliding clamp attached to the rail. The free-fall mass is movably guided relative to the impact part in this case. The free-fall mass is in this context guided in such a way that the free-fall mass, which is initially raised to a certain free-fall height, transmits an impulse that is dependent on the certain free-fall height to the sliding clamp via the impact part supported on the sliding clamp at the end of its free-fall. The term sliding clamp refers to conventional rail securing elements, which are also known as sliding brackets, sliding lugs or sliding or clamping claws. They serve for securing the guide rail on a substructure such as a wall angle or carrier plate.

In this case, the free-fall height for the free-fall mass of the impact device can be suitably determined for the respective application. For example, an identical free-fall height for the raised free-fall mass can be adjusted for all sliding clamps of a certain rail type. This identical free-fall height can then be tested and used as default setting for other elevator installations with the same sliding clamp/rail type combination. For example, several identical elevator installations may also be provided within one building. In this case, the required free-fall height for the collective realignment of all elevator installations can be determined during the realignment of the first elevator installation to be readjusted. The thusly determined free-fall height can then be used for all other elevator installations of the corresponding building. Consequently, significant time savings for the realignment can also be realized in instances, in which the corresponding free-fall height for the respective rail type is initially not known. Another advantage compared with a different impact tool such as a hammer can be seen in that damages to the sliding clamps, the guide rails and other securing elements are prevented by using this impact device.

In the method for realigning rail securing devices of elevator installations, which serve for holding at least one rail, particularly a guide rail, of the elevator installation, successive steps are advantageously carried out on each sliding clamp. In this case, a corresponding rail securing device respectively features a sliding clamp that is arranged on the guide rail. The impact part of the impact device is initially supported on the sliding clamp. A free-fall height is defined in this case and the free-fall mass is raised to this free-fall height. The free-fall mass raised to the certain free-fall height is subsequently dropped such that it transmits an impulse, which is dependent on the certain free-fall height, to the sliding clamp via the impact part supported on the sliding clamp at the end of its free-fall. The sliding securing device is respectively released from its tensioned position due to this impulse or transmitted impact energy. The system is then essentially reset into the nominal position due to the mechanical stress in the rail securing device.

A realignment of rails, particularly guide rails, due to jammed or warped rail securing devices consequently can be carried out with a reduced expenditure of time and reduced costs. In this case, the free-fall mass on the individual rail securing devices preferably is respectively raised exactly as high as required for once again returning the rail securing device into its nominal position.

It is advantageous to provide an attachment part, which can be placed against the rail of the elevator installation in order to arrange the impact part on the rail of the elevator installation, and to provide at least one mounting bracket, which is connected to the attachment part and holds the attachment part on the rail in a closed state. The impact part is secured with corresponding play such that it can largely transmit the impact energy generated by the free-fall mass to the sliding clamp. In this context, it is furthermore advantageous if the attachment part features a longitudinal groove, into which the rail can be at least partially inserted, and if the mounting bracket engages behind the rail, which is at least partially inserted into the longitudinal groove, in the closed state. In this case, it is preferred to provide several mounting brackets, particularly two mounting brackets. In this way, the impact part can be reliably secured on the rail in order to position the impact part relative to the sliding clamp.

It is furthermore advantageous to provide a base body that comprises the impact part and the attachment part. The impact part and the attachment part may be integrally connected to one another. The impact part and the attachment part may also be realized in one piece. In this way, an advantageous design can be realized.

It is furthermore advantageous if the impact part features a guide groove, into which the rail can be at least partially inserted. In this way, the impact part can on the one hand be attached to the rail in an improved fashion in order to thereby ensure that the impact part reliably contacts the sliding clamp during the transmission of the impulse to the sliding clamp. On the other hand, a certain guidance of the impact part on the rail can be realized, if necessary, such that a defined position of the impact part relative to the sliding clamp is ensured.

It is advantageously proposed that a guide rod is provided, that the free-fall mass features an axial bore, that the guide rod extends through the axial bore of the free-fall mass, and that one end of the guide rod is connected to the impact part. In this case, the end of the guide rod, which is connected to the impact part, may entirely or partially extend through the impact part. During its free-fall, the free-fall mass initially is reliably guided to a defined location of the impact part by means of the guide rod. Furthermore, the free-fall mass has a defined orientation relative to the impact part when it strikes the impact part. For example, a planar cooperation of the free-fall mass with the impact part can thereby be achieved in the instant, in which the free-fall mass strikes the impact part, in order to thereby transmit the impulse triggered by the free-fall mass to the sliding clamp.

It is therefore also advantageous if an underside of the impact part is realized in such a way that the impact part can with its underside come in planar contact with an upper side of the sliding clamp. However, other designs and configurations are also conceivable in this respect. The impulse may also be transmitted from the free-fall mass to the impact part via an intermediate element, particularly a spring element. Such a spring element may be realized, for example, in the form of a disk spring in order to ultimately influence relevant releasing forces exerted upon the sliding clamp. However, such an element may also consist of a metallic or non-metallic layer of a suitable material for achieving a certain damping effect. For example, the element may be realized in the form of a copper layer that is produced, e.g., of a copper sheet. The element may furthermore be realized in the form of an insert that is inserted into the impact part in the region, in which it is struck by the free-fall mass. Such an element may accordingly also be provided between the impact part and the sliding clamp and serve for supporting the impact part on the sliding clamp. However, the impact part may also be directly supported on the sliding clamp.

It is furthermore advantageous to provide several free-fall height markings on the base body, particularly the attachment part, in order to thereby mark different levels for the certain free-fall height. For example, the corresponding free-fall height for the respective rail type can thereby be defined. It is furthermore possible to predefine a certain free-fall height by means of an adjustable adjusting element, particularly a clamping element. The realigning method can thereby be simplified because the free-fall element merely has to be raised to a certain predefined free-fall height by means of the adjustable adjusting element.

It is also advantageous to define the free-fall height in such a way that the releasing force generated by the impulse transmitted to the sliding clamp is greater than a static friction between the sliding clamp and the guide rail minus an expected bending force, which is caused by a deflection of the rail securing device and lower than the static friction. If the free-fall height is defined in this fashion, the transmitted impulse results in a releasing force that suffices for once again resetting the rail securing device into its nominal position, but does not lead to overbending.

It is accordingly advantageous if the free-fall mass is typically raised to the certain free-fall height exactly when the impact device is supported on the respective sliding clamp with its impact part. Simply raising the free-fall mass will therefore typically suffice. However, it may also occur that the releasing force generated by raising the free-fall mass to the certain free-fall height does not suffice in certain instances, particularly due to significant soiling, already existing mechanical deflections or other circumstances that significantly deviate from the expected state. If necessary, the free-fall mass may have to be raised once again in such instances. Such special instances may, if applicable, also require a manual intervention, particularly cleaning or repairing the sliding clamp.

### DESCRIPTION OF THE DRAWINGS

Preferred exemplary embodiments of the invention are described in greater detail below with reference to the attached drawings, in which corresponding elements are identified by identical reference symbols. In these drawings:

FIG. 1 shows a schematic sectional representation of part of a building with an elevator installation according to a potential embodiment in order to elucidate the function of the invention;

FIG. 2 shows a schematic three-dimensional representation of an impact device according to an exemplary embodiment of the invention, which is arranged on a guide rail;

FIG. 3 shows a schematic three-dimensional representation of the impact device according to FIG. 2 during the arrangement on the guide rail;

FIG. 4 shows a schematic three-dimensional representation of the impact device according to FIG. 3, which is arranged on the guide rail;

FIG. 5 shows a schematic representation of the impact device according to the exemplary embodiment of the invention, which is arranged on the guide rail, while the method for realigning a rail securing device for the guide rail is carried out, and

FIG. 6 shows the impact device according to FIG. 5, which is arranged on the guide rail, wherein the rail securing device has been realigned by means of the impact device.

### DETAILED DESCRIPTION

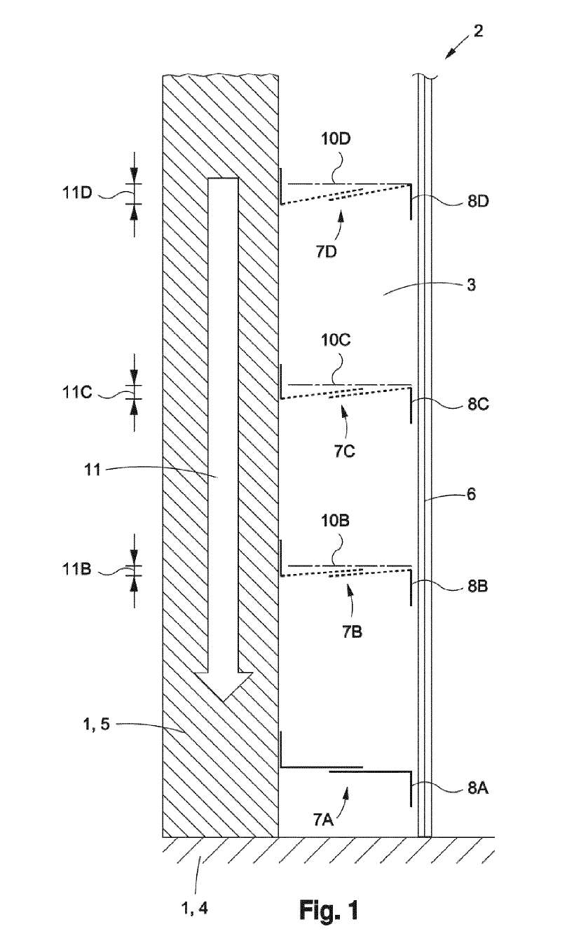

FIG. 1 shows a schematic sectional representation of part of a building 1 with an elevator installation 2 according to a potential embodiment, particularly a region with a guide rail 6 that is secured on a shaft wall 5, in order to elucidate the function of the invention. In this case, an elevator shaft 3 is provided in the building 1 and defined by a shaft bottom 4 and the lateral shaft wall 5. The building 1 naturally also features other components, but only the shaft bottom 4 and the shaft wall 5 are illustrated in order to simplify the drawing.

The elevator installation 2 features the rail 6 and several rail securing devices 7A, 7B, 7C, 7D for the rail 6. The rail 6 is realized in the form of a guide rail 6 in this exemplary embodiment. The elevator installation 2 also features a number of additional elements, particularly an elevator car that may be guided on the guide rail 6, a power plant, a counterweight and a traction mechanism. These additional elements are likewise not illustrated in order to simplify the drawing.

The rail securing devices 7A, 7B, 7C, 7D respectively feature sliding clamps 8A, 8B, 8C, 8D that are arranged on the guide rail 6.

An initial position or nominal position, in which the rail securing devices 7A-7D should be installed, is respectively predefined for the rail securing devices 7A-7D. For example, the rail securing devices 7A-7D may in the nominal position be aligned horizontally as it is the case with the rail securing device 7A and illustrated with dot-dash lines 10B, 10C, 10D in the drawing.

However, a new building 1 continues to settle due to the progressive curing of concrete. In this context, length changes relevant to the position of the rail securing devices 7A-7D can occur over the course of several months or even an entire year. The contraction of the shaft wall 5 particularly causes a length change in the direction 11. However, the steel guide rail 6 is not subjected to any comparable length change. Consequently, relative length changes 11B, 11C, 11D between the shaft wall 5 and the guide rail 6 occur in the vertical direction at the locations of the rail securing devices 7B, 7C, 7D. Depending on the respective suspension or support of the guide rail 6 and the occurring mechanical stresses, however, no relative length change may occur on individual rail securing devices 7A as indicated, for example, on the rail securing device 7A. The rail securing device 7A is therefore in its nominal position. Furthermore, the sliding clamps 8A-8D are designed in such a way that a relative motion referred to the guide rail 6 preferably takes place. A corresponding rail securing device, on which such a compensation takes place successfully, is likewise in its nominal position.

However, the sliding mechanism for realizing a relative motion or sliding motion between the sliding clamps 8B, 8C, 8D and the guide rail 6 may also malfunction. This may be caused by jamming or warping of the sliding clamps 8B, 8C, 8D on the guide rail 6. Consequently, a realignment of the rail securing devices 7A-7D should be carried out within a certain period of time after the elevator installation has been installed, particularly within one year. A realignment of the guide rail 6 is thereby achieved. This realignment improves the riding comfort in the elevator car, for example, because horizontal vibrations of the elevator car can be reduced.

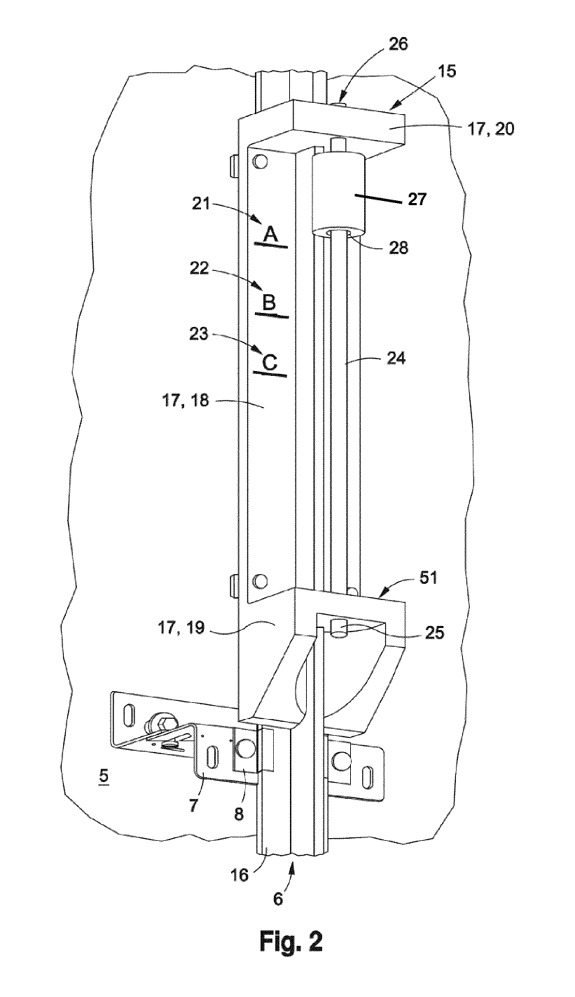

FIG. 2 shows a schematic three-dimensional representation of an impact device 15 according to an exemplary embodiment of the invention, which is arranged on a guide rail 6. The guide rail 6 features a rail flange 16, on which the sliding clamp 8 of a rail securing device 7 is arranged. In this case, the rail securing device 7 and the sliding clamp 8 respectively represent examples of one of the rail securing devices 7A-7D or one of the sliding clamps 8A-8D described above with reference to FIG. 1 if a realignment is required at this location. The impact device 15 features a base body 17. The base body 17 comprises an attachment part 18, an impact part 19 and an upper holding part 20. The attachment part 18, the impact part 19 and the holding part 20 may be integrally connected to one another or realized in one piece.

Vertically distributed markings 21, 22, 23 are provided on the attachment part in this exemplary embodiment. Designations may be provided on the markings 21, 22, 23 as indicated with the letters A, B, C.

The impact device 15 also features a guide rod 24. In this exemplary embodiment, one end 25 of the guide rod 24 extends through the impact part 19, wherein the end 25 is connected to the impact part 19. Another end 26 of the guide rod 24 extends through the base body 17, wherein the other end 26 is connected to the base body 17. A free-fall mass 27 is arranged on the guide rod 24. In this case, the free-fall mass 27 features an axial bore 28, through which the guide rod 24 extends. The free-fall mass 27 is thereby guided on the guide rod 24.

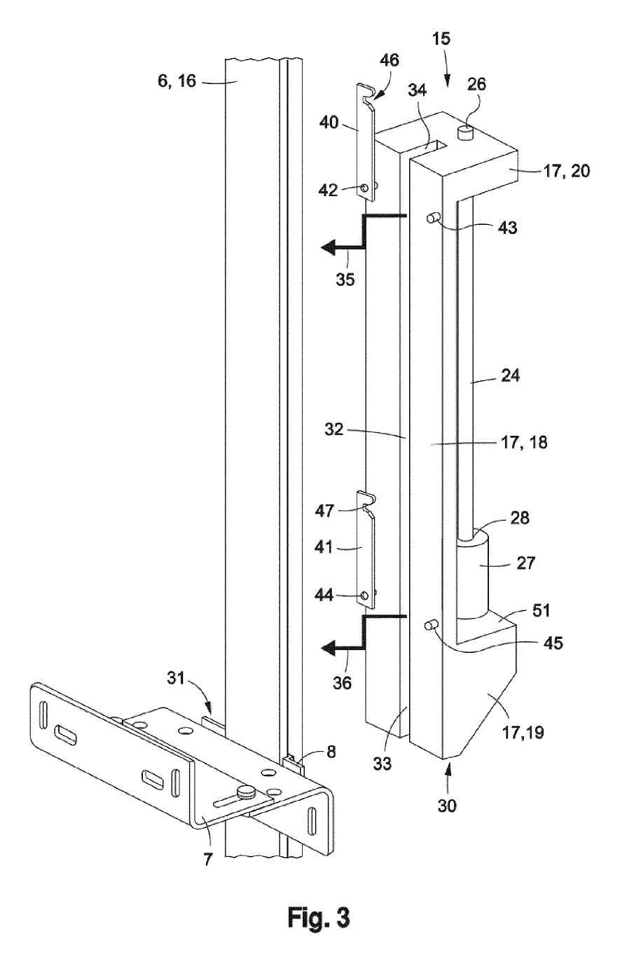

FIG. 3 shows a schematic three-dimensional representation of the impact device 15 according to FIG. 2 during the arrangement on the guide rail 6. The impact part 19 features an underside 30, which is realized in such a way that the impact part 19 can with its underside 30 come in planar contact with an upper side 31 of the sliding clamp 8. The attachment part 18 also features a longitudinal groove 32, into which the guide rail 6 can be at least partially inserted. Furthermore, the impact part 19 features a guide groove 33, into which the guide rail 6 can be at least partially inserted. Another guide groove 34, into which the guide rail 6 can be at least partially inserted, is provided on the holding part 20. Due to the one-piece design of the base body 17, the longitudinal groove 32 and the guide grooves 33, 34 form one continuous groove 32, 33, 34.

During the arrangement of the impact device 15 on the guide rail 6 above the sliding clamp 8, the impact device 15 is joined with the continuous groove 32, 33, 34 on the guide rail 6 as indicated with the arrows 35, 36. In this case, the base body 17 is supported on the sliding clamp 8 with its impact part 19 in the joined state. The base body 17 is subsequently secured on the guide rail 6.

Mounting brackets 40, 41 serve for securing the base body 17 on the guide rail 6. The mounting bracket 40 is pivotably supported on a pin 42. In addition, a pin 43 is provided and a recess 46 of the mounting bracket 40 is assigned to said pin. Pins 44, 45 are accordingly provided. In this case, the mounting bracket 41 is pivotable about the pin 44. A recess 47 of the mounting bracket 41 is assigned to the pin 45. The pins 42-45 are connected to the base body 17.

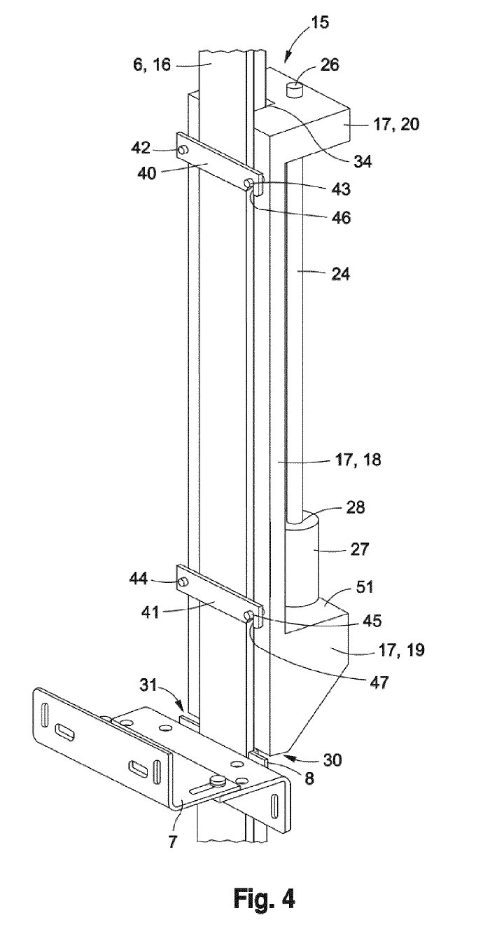

FIG. 4 shows a schematic three-dimensional representation of the impact device 15 according to FIG. 3, which is arranged on the guide rail 6. The mounting brackets 40, 41 are illustrated in the closed state in this figure. In this case, the pin 43 engages into the recess 46 of the mounting bracket 40. Furthermore, the pin 45 engages into the recess 47 of the mounting bracket 41. In the closed state, the mounting brackets 40, 41 engage behind the guide rail 6, which is partially inserted into the continuous groove 32, 33, 34, such that the impact device 15 is reliably held on the guide rail 6. The mounting brackets 40, 41 merely secure the impact device 15 against tilting away from the guide rail 6 while it vertically rests on the sliding clamps 8.

The impact part 19 therefore is reliably arranged on the guide rail 6 in a suitable fashion when the attachment part 18 is placed against the guide rail 6 as described above and the attachment part 18 is held on the guide rail 6 by means of the closed mounting brackets 40, 41. A purposeful impulse can then be reliably transmitted to the sliding clamp 8 by raising the free-fall mass 27 and subsequently dropping the free-fall mass 27.

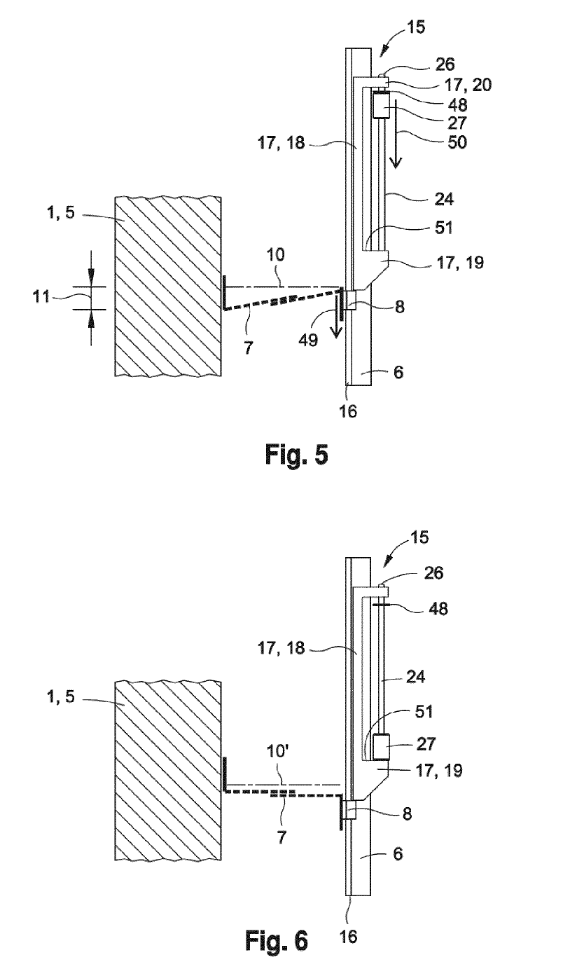

FIG. 5 shows a schematic representation of the impact device 15 according to the exemplary embodiment, which is arranged on the guide rail 6, while the method for realigning a rail securing device 7 for the guide rail 6 is carried out. In this case, an exemplary relative length change 11 has occurred, e.g., due to progressive curing of the shaft wall 5. It is furthermore assumed that no corresponding compensation has taken place on the sliding clamp 8. This may be caused, for example, by the sliding clamp 8 jamming on the rail flange 16. A deflection of the rail securing device 7 from the original nominal position 10 therefore takes place. Mechanical stresses occur in the rail securing device 7 during this process.

The free-fall mass 27 is then raised to a certain free-fall height. For example, the markings 21, 22, 23 may be used for this purpose as described above with reference to FIG. 2. It is furthermore possible to predefine the certain free-fall height by means of an adjustable adjusting element 48. For example, the adjustable adjusting element 48 may be clamped on the guide rod 24.

In this context, the free-fall height is defined in such a way that the releasing force generated by the impulse transmitted to the sliding clamp 8 is greater than a static friction between the sliding clamp 8 and the guide rail 6 minus an expected bending force, which is caused by a deflection of the rail securing device 7 and lower than the static friction. This ensures that the releasing force generated by the free-fall mass 27 and the expected bending force of the bent rail securing device 7 collectively suffice for releasing the sliding clamp 8, for example, from its jammed position on the guide rail 6. In this way, the compensation mechanism between the sliding clamp 8 and the rail 6 is once again operative such that the rail securing device 7 is automatically reset into an at least largely stress-free position.

On the other hand, the releasing force defined by the certain free-fall height of the free-fall mass 27 is by itself lower than the static friction between the sliding clamp 8 and the guide rail 6. This prevents an undesirable deflection of the rail securing device 7 in the releasing direction 49.

When the method for realigning the rail securing device 7 is carried out, the free-fall mass 27 therefore is typically raised exactly to the defined free-fall height. In this case, the free-fall direction 50 along the guide rod 24 is preferably oriented at least approximately in the direction of the gravitational force.

FIG. 6 shows the impact device 15 according to FIG. 5, which is arranged on the guide rail 6, wherein the rail securing device 7 has been realigned by means of the impact device 15. In this case, the free-fall mass 27 rests on an upper side 51 of the impact part 19. After the sliding clamp 8 has been respectively released or struck loose, the rail securing device 7 is in its new nominal position 10′. In the new nominal position 10′, the mechanical stresses in the rail securing device 7 are significantly reduced in comparison with the state illustrated in FIG. 5.

The running properties of the elevator installation are improved due to the reduction of the mechanical stresses of the rail securing device 7.

The impact energy and therefore the releasing force is preferably adapted to the respective application, particularly to the respective type of guide rail 6, by predefining the certain free-fall height. However, other adaptations are also conceivable. For example, the size of the free-fall mass 27 may be adapted to the respective application. Since the releasing force is generated by the impulse change when the free-fall mass 27 strikes the impact part 19, a corresponding adaptation can likewise be achieved by predefining the damping effect and therefore the transmission time. This can be realized with the material pairing between the impact part 19 and the free-fall mass 27. An intermediate element, particularly a disk spring, may also be provided in this case.

For example, such an intermediate element may be placed on the upper side 51 of the impact part 19. Inserts may furthermore also be inserted into the impact part 19.

A significant advantage can be seen in that the impact device 15 only has to be set up once for a certain type of guide rail 6. If necessary, this may also be realized experimentally. Subsequently, all rail securing devices 7 for this type of guide rail 6 can preferably be realigned with the same impact energy. The certain free-fall height for the free-fall mass 27 can thereby be defined for at least one type of guide rail 6.

The invention is not limited to the described exemplary embodiments. For example, the impact energy may be increased by installing an acceleration spring or the groove 32, 33, 34 may be adapted to corresponding rail dimensions, for example, by means of inserts.

In accordance with the provisions of the patent statutes, the present invention has been described in what is considered to represent its preferred embodiment. However, it should be noted that the invention can be practiced otherwise than as specifically illustrated and described without departing from its spirit or scope.

1-10. (canceled)

11. An impact device for aligning rail securing devices of an elevator installation, the rail securing devices fixing a guide rail on an elevator shaft wall, comprising:
an impact part arranged on the guide rail and supported on a sliding clamp attached to the guide rail; and
a free-fall mass movably guided relative to the impact part, wherein the free-fall mass, when initially raised to a predetermined free-fall height, transmits an impulse to the sliding clamp through striking the impact part supported on the sliding clamp at an end of a free-fall of the free-fall mass from the predetermined free-fall height.

12. The impact device according to claim 11 including an attachment part placed against the guide rail to arrange the impact part on the guide rail, and at least one mounting bracket connected to the attachment part and holding the attachment part on the guide rail.

13. The impact device according to claim 12 wherein the attachment part has a longitudinal groove into which the guide rail is at least partially inserted, and the at least one mounting bracket engages behind the guide rail opposite the attachment part.

14. The impact device according to claim 12 including a base body wherein the base body integrally connects the impact part and the attachment part or the base body forms the impact part and the attachment part as one piece.

15. The impact device according to claim 11 wherein the impact part has a guide groove into which the guide rail is at least partially inserted.

16. The impact device according to claim 11 including a guide rod, wherein the free-fall mass has an axial bore through which bore the guide rod, and one end of the guide rod is connected to the impact part.

17. The impact device according to claim 11 where in the impact part has an underside in planar contact with an upper side of the sliding clamp.

18. The impact device according to claim 11 including at least one of at least two free-fall height markings representing different levels for the predetermined free-fall height and an adjustable adjusting element for setting the predetermined free-fall height.

19. A method for realigning rail securing devices of an elevator installation, the rail securing devices holding at least one guide rail of the elevator installation on an elevator shaft wall, at least one of the rail securing devices having a sliding clamp arranged on the at least one guide rail, comprising the steps of:
arranging an impact device on the at least one guide rail with an impact part of the impact device supported on the sliding clamp;
defining a free-fall height and raising a free-fall mass of the impact device to the defined free-fall height; and
allowing the free-fall mass to free-fall from the defined free-fall height and strike the impact part thereby transmitting an impulse to the sliding clamp.

20. The method according to claim 19 wherein the impulse transmitted to the sliding clamp generates a releasing force that is greater than a static friction between the sliding clamp and the at least one guide rail minus an expected bending force, which bending force is caused by a deflection of the rail securing device, and is lower than the static friction.
